(19) United States
(12) Patent Application Publication
(10) Pub. No.: US 2017/0285904 A1
(43) Pub. Date: Oct. 5, 2017

(54) DIRECT DATA TRANSFER ELECTRONIC DEVICE AND METHOD

(71) Applicant: Hassan KHALAFALLAH, Honolulu, HI (US)

(72) Inventor: Hassan KHALAFALLAH, Honolulu, HI (US)

(21) Appl. No.: 15/088,936

(22) Filed: Apr. 1, 2016

(51) Int. Cl. G06F 3/0488; G06F 3/0485; G06K 9/00; G06F 3/0481

(52) U.S. Cl. CPC G06F 3/0488; G06F 3/04817; G06F 3/0485; G06K 9/00013; G06K 9/00087

(57) ABSTRACT

Systems and methods are described herein for manipulating data of an electronic device, including a means for opening a displayed icon, a means for displaying one or more sets of properties of the displayed icon, and a means for activating one or more features of the displayed icon. The manipulating data also includes a means for transferring data of a file or folder represented by the displayed icon from the electronic device to a second electronic device when the second electronic device is located within a distance equal to or less than a maximum threshold distance from the electronic device.

### GRANT OF NON-EXCLUSIVE RIGHT

This application was prepared with financial support from the Saudi Arabian Cultural Mission, and in consideration therefore the present inventor(s) has granted The Kingdom of Saudi Arabia a non-exclusive right to practice the present invention.

### BACKGROUND

Transferring data between different types of electronic devices requires using an intermediary computing device. In addition, transferring data from one electronic device to two or more other electronic devices requires multiple intermediary computing devices between the sending device and each of the receiving devices.

The “background” description provided herein is for the purpose of generally presenting the context of the disclosure. Work of the presently named inventors, to the extent it is described in this background section, as well as aspects of the description which may not otherwise qualify as being conventional at the time of filing, are neither expressly nor impliedly admitted as being conventional against the present disclosure.

### SUMMARY

Embodiments include an electronic device having a touch panel by which a user selects one or more inputs on a graphical user interface (GUI) displayed on a display screen to initiate one or more functions. The electronic device also includes processing circuitry configured to open a displayed icon when a first extended touch of a time equal to or greater than a minimum time of touch by a finger or stylus is detected upon the displayed icon on the touch panel of the electronic device. The processing circuitry is also configured to display one or more sets of properties of the displayed icon when one or more fast clicks by the finger or stylus are detected upon the displayed icon. The processing circuitry is also configured to activate one or more features of the displayed icon when a continuous scrolling motion is detected upon the displayed icon of the electronic device subsequent to detecting a second extended touch by the finger or stylus upon the displayed icon on the touch panel of the electronic device. A time of the second extended touch is less than a time of the first extended touch. The processing circuitry is also configured to transfer data of a file or folder represented by the displayed icon from the electronic device to a second electronic device located within a distance equal to or less than a maximum threshold distance when a rolling scroll motion towards the second electronic device is detected upon the displayed icon of the electronic device subsequent to detecting a third extended touch by the finger or stylus upon the displayed icon representing the file or folder. A time of the third extended touch is less than a time of the first extended touch.

Embodiments also include a method of manipulating data, including the following steps. When a first extended touch of a time equal to or greater than a minimum time of touch by a finger or stylus is detected upon a displayed icon on a touch panel of an electronic device, the displayed icon is opened. When one or more fast clicks by the finger or stylus are detected upon the displayed icon, one or more sets of properties of the displayed icon are displayed. When a continuous scrolling motion is detected upon the displayed icon of the electronic device subsequent to detecting a second extended touch by the finger or stylus upon the displayed icon on the touch panel of the electronic device, one or more features of the displayed icon are activated, via a processor. A time of the second extended touch is less than a time of the first extended touch. When a rolling scroll motion towards a second electronic device is detected upon the displayed icon of the electronic device subsequent to detecting a third extended touch by the finger or stylus upon the displayed icon representing a file or folder, data of the file or folder represented by the displayed icon is transferred from the electronic device to the second electronic device when the second electronic device is located within a distance equal to or less than a maximum threshold distance from the electronic device. A time of the third extended touch is less than a time of the first extended touch.

Embodiments also include an electronic device having means for opening a displayed icon when a first extended touch of a time equal to or greater than a minimum time of touch by a finger or stylus is detected upon the displayed icon on the touch panel of the electronic device. The electronic device also includes means for displaying one or more sets of properties of the displayed icon when one or more fast clicks by the finger or stylus are detected upon the displayed icon. The electronic device also includes means for activating one or more features of the displayed icon when a continuous scrolling motion is detected upon the displayed icon of the electronic device subsequent to detecting a second extended touch by the finger or stylus upon the displayed icon on the touch panel of the electronic device, wherein a time of the second extended touch is less than a time of the first extended touch. The electronic device also includes means for transferring data of a file or folder represented by the displayed icon from the electronic device to a second electronic device located within a distance equal to or less than a maximum threshold distance when a rolling scroll motion towards the second electronic device is detected upon the displayed icon of the electronic device subsequent to detecting a third extended touch by the finger or stylus upon the displayed icon representing the file or folder, wherein a time of the third extended touch is less than a time of the first extended touch.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an exemplary device according to an embodiment;

FIG. 2 is a block diagram of an exemplary electronic device according to an embodiment;

FIG. 3 illustrates some exemplary icons according to an embodiment;

FIG. 4A illustrates special icons for password files, e-mail files, and settings according to an embodiment;

FIG. 4B illustrates special icons for folder files, home, and search according to an embodiment;

FIG. 5 illustrates an exemplary reorganization of icons according to an embodiment;

FIG. 6 illustrates scrolling directions of a touchscreen according to an embodiment;

FIG. 7 is an algorithm for manipulating icons on a touchscreen according to an embodiment;

FIG. 8 is an exemplary method of manipulating data according to an embodiment;

FIG. 9 illustrates a touch screen and a fingerprint touch sensor according to an embodiment; and

FIG. 10 illustrates multiple fingerprint digits used for identification according to an embodiment.

### DETAILED DESCRIPTION

Embodiments herein describe an electronic device configured to transfer data to one or more other electronic devices without the use of an intermediary computing device. Embodiments herein also describe an electronic device configured with circuitry to manipulate displayed icons, display properties of displayed icons, and activate features of the displayed icons. A touch screen is integrally formed with the electronic device, in which data can be read and files can be transferred to other electronic devices, via a USB, Bluetooth, or wireless fidelity (WiFi). Embodiments provide storage and transfer of media from the same electronic device to another electronic device, without an intermediary computing device.

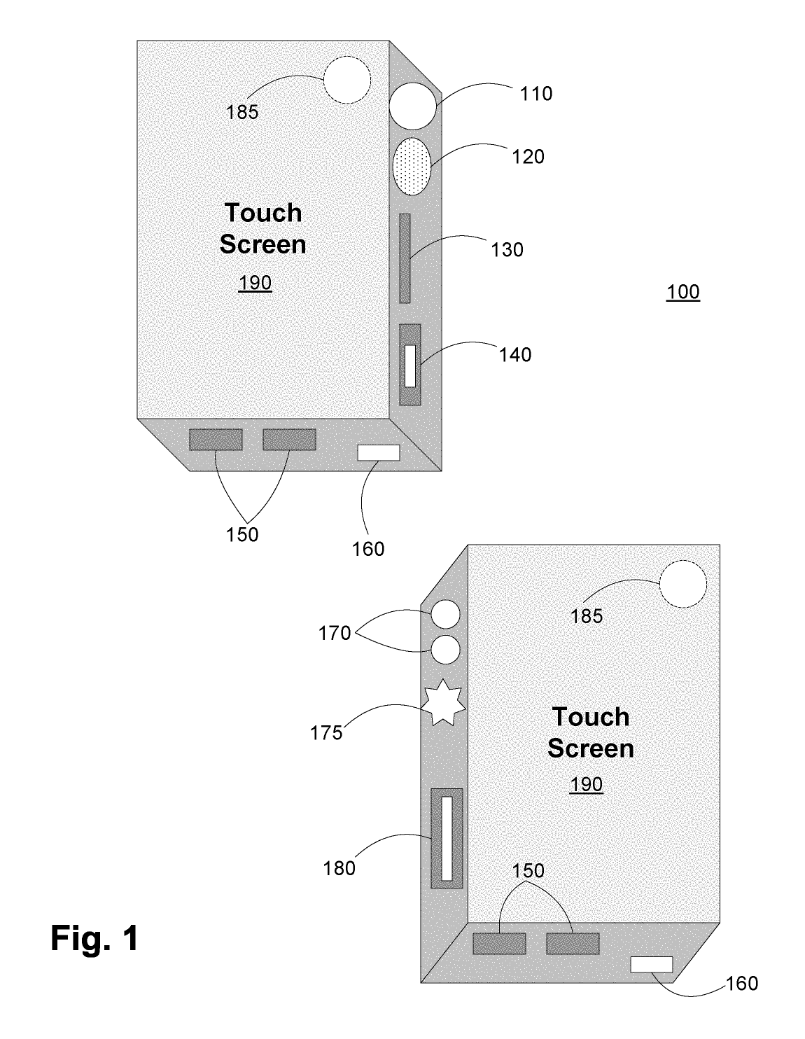

FIG. 1 illustrates an exemplary electronic device 100 according to embodiments described herein. FIG. 1 illustrates sharp borders and corners of the electronic device 100. However, other embodiments described herein include rounded borders and corners of the electronic device 100.

Electronic device 100 includes a power button 110 and a fingerprint identification button 120 on a right edge of the electronic device 100. A memory card slot 130 and a micro USB port 140 are also illustrated on the right edge of electronic device 100. Multiple USB ports 150 are illustrated on a lower edge of electronic device 100, along with a charger port 160. A left edge of electronic device 100 illustrates volume buttons 170 for increasing and decreasing the volume and a ports light switch 175. Ports light switch 175 provides a lighted background for each of the ports and slots to assist in connecting a connection cord to the electronic device 100. A micro HDMI slot 180 is also illustrated on the left edge of electronic device 100.

Electronic device 100 also illustrates a camera 185. Camera 185 can be configured with multiple lenses, such as a telescopic lens and a wide-angle lens, and it can also include a scanner. Camera 185 can be configured in a different location, such as a top center position or a top left position of electronic device 100. The various buttons, ports, and slots can be positioned differently or can have a different quantity than as illustrated in FIG. 1. In addition, not all buttons, ports, and slots need to be present on electronic device 100, and other buttons, ports, and slots not illustrated can be included on electronic device 100 in embodiments described herein.

Electronic device 100 can be configured with multiple sensors, including but not limited to a light sensor, an accelerometer, a gyroscopic sensor, a proximity sensor, a compass, a barometer, and/or a gesture sensor. Electronic device 100 can also be configured with multiple communication capabilities, including but not limited to WiFi, Bluetooth, near-field communication (NFC), infrared (IR), and/or Guidance Positioning System (GPS). Electronic device 100 includes a touch screen 190 on a front face, which is also configured as a display screen for viewing results.

In an embodiment, electronic device 100 is a hard disk drive (HDD) device. However, other forms of memory devices are contemplated by embodiments described herein, such as a flash memory device.

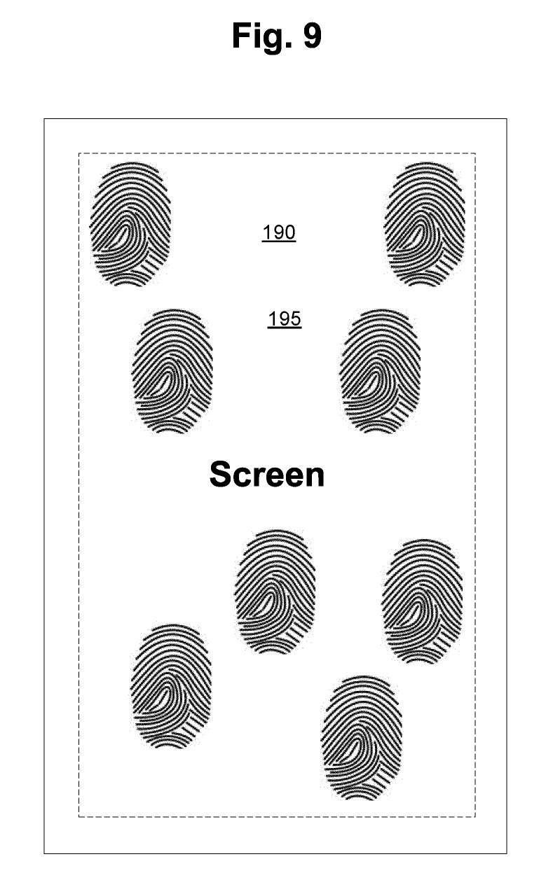

FIG. 1 illustrates a single fixed location for fingerprint identification button 120. However, FIG. 9 illustrates an alternative embodiment for a fingerprint identification system. FIG. 9 illustrates touch screen 190, in addition to a fingerprint touch sensor 195. Fingerprint touch sensor 195 occupies an entire area of the touch screen 190. Since the fingerprint touch sensor 195 occupies the entire screen display area, a user can press his/her fingerprint anywhere onto the touch screen 190 to be identified. The fingerprint touch sensor 195 does not need a specific position or region for receiving a fingerprint. The screen illustrated in FIG. 9 servers as the touch screen 190, a display screen, and the fingerprint touch sensor 195 all in one area. The touch screen 190 includes the fingerprint touch sensor 195 configured to receive a fingerprint pressed against an area of the touch screen 190 and to compare the received fingerprint with a fingerprint stored in a memory of the electronic device 100.

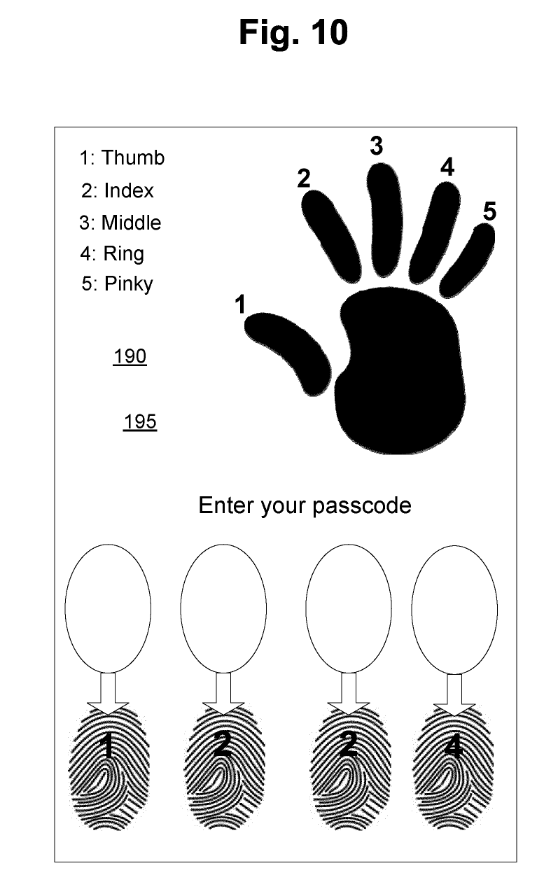

FIG. 10 illustrates another alternative embodiment in which multiple fingerprint digits can be used for identification. In an embodiment, any one of digits one through four or digits one through five can be used for identification on the fingerprint touch sensor 195 of the touch screen 190. In another embodiment, multiple digits are used together, either simultaneously or in succession, such as digits one through three or digits two through five. The touch screen 190 includes the fingerprint touch sensor 195 configured to receive one or more fingerprints from one or more finger digits and to compare the received fingerprints with fingerprints stored in a memory of the electronic device 100.

In an example, given for illustrative purposes only, a user can select four finger digits to be taken as one password. In FIG. 10, the thumb is used for the first finger digit, the index finger is used for both the second finger digit and the third finger digit. The ring finger is used as the fourth finger digit. However, any other combination of the five finger digits can be used to create a unique fingerprint. The four digits can be applied simultaneously or in succession. If the four digits are entered in succession, they are entered in a pre-established order. The fingerprint touch sensor 195 is configured to receive a pre-determined succession of fingerprints from the one or more finger digits and to compare the received pre-determined succession of fingerprints with the fingerprints stored in the memory of the electronic device 100.

In another example, given for illustrative purposes only, a user can define multiple fingerprint patterns for multiple users. For example, a primary user can be authorized for full access to the electronic device 100 having his/her unique fingerprint pattern. A second user, such as a child, might have limited access to files, games, and the Internet and would have his/her unique fingerprint pattern. A third fingerprint pattern can be established for guests.

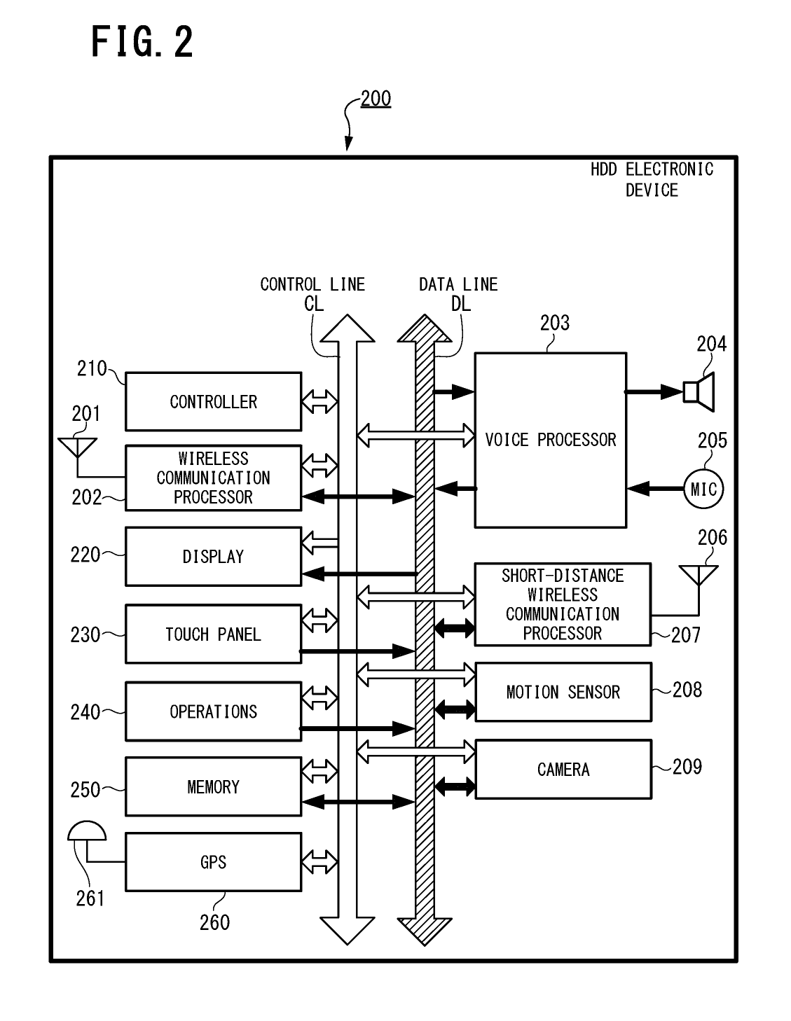

FIG. 2 is a block diagram illustrating an exemplary electronic device 200 that could be used to implement one or more embodiments of the present disclosure. Electronic device 200 could be used as electronic device 100 illustrated in FIG. 1. The exemplary electronic device 200 includes a controller 210 and a wireless communication processor 202 connected to an antenna 201. A speaker 204 and a microphone 205 are connected to a voice processor 203.

The controller 210 can include one or more Central Processing Units (CPUs), and can control each element in the electronic device 200 to perform functions related to communication control, audio signal processing, control for the audio signal processing, still and moving image processing and control, and other kinds of signal processing. The controller 210 can perform these functions by executing instructions stored in a memory 250. Alternatively or in addition to the local storage of the memory 250, the functions can be executed using instructions stored on an external device accessed on a network or on a non-transitory computer readable medium.

The memory 250 includes but is not limited to Read Only Memory (ROM), Random Access Memory (RAM), or a memory array including a combination of volatile and non-volatile memory units. The memory 250 can be utilized as working memory by the controller 210 while executing the processes and algorithms of the present disclosure. Additionally, the memory 250 can be used for long-term storage, e.g., of image data and information related thereto.

The electronic device 200 includes a control line CL and data line DL as internal communication bus lines. Control data to/from the controller 210 can be transmitted through the control line CL. The data line DL can be used for transmission of voice data, display data, etc.

The antenna 201 transmits/receives electromagnetic wave signals between base stations for performing radio-based communication, such as the various forms of cellular telephone communication. The wireless communication processor 202 controls the communication performed between the electronic device 200 and other external devices via the antenna 201. For example, the wireless communication processor 202 can control communication between base stations for cellular phone communication.

The speaker 204 emits an audio signal corresponding to audio data supplied from the voice processor 203. The microphone 205 detects surrounding audio and converts the detected audio into an audio signal. The audio signal can then be output to the voice processor 203 for further processing. The voice processor 203 demodulates and/or decodes the audio data read from the memory 250 or audio data received by the wireless communication processor 202 and/or a short-distance wireless communication processor 207. Additionally, the voice processor 203 can decode audio signals obtained by the microphone 205.

The exemplary electronic device 200 can also include a display 220, a touch panel 230, an operations key 240, and a short-distance communication processor 207 connected to an antenna 206. The display 220 can be a Liquid Crystal Display (LCD), an organic electroluminescence display panel, or another display screen technology. In addition to displaying still and moving image data, the display 220 can display operational inputs, such as numbers or icons which can be used for control of the electronic device 200. The display 220 can additionally display a GUI for a user to control aspects of the electronic device 200 and/or other devices. Further, the display 220 can display characters and images received by the electronic device 200 and/or stored in the memory 250 or accessed from an external device on a network. For example, the electronic device 200 can access a network such as the Internet and display text and/or images transmitted from a Web server.

The touch panel 230 can include a physical touch panel display screen and a touch panel driver. The touch panel 230 can include one or more touch sensors for detecting an input operation on an operation surface of the touch panel display screen. The touch panel 230 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus can include a conductive material at least at the tip of the stylus such that the sensors included in the touch panel 230 can detect when the stylus approaches/contacts the operation surface of the touch panel display (similar to the case in which a finger is used for the touch operation).

According to aspects of the present disclosure, the touch panel 230 can be disposed adjacent to the display 220 (e.g., laminated) or can be formed integrally with the display 220. For simplicity, the present disclosure assumes the touch panel 230 is formed integrally with the display 220 and therefore, examples discussed herein can describe touch operations being performed on the surface of the display 220 rather than the touch panel 230. Touch screen 190 is an example of an integrally-formed display 220 and touch panel 230. However, the skilled artisan will appreciate that this is not limiting.

For simplicity, the present disclosure assumes the touch panel 230 is a capacitance-type touch panel technology. However, it should be appreciated that aspects of the present disclosure can easily be applied to other touch panel types (e.g., resistance-type touch panels) with alternate structures. According to aspects of the present disclosure, the touch panel 230 can include transparent electrode touch sensors arranged in the X-Y direction on the surface of transparent sensor glass.

The touch panel driver can be included in the touch panel 230 for control processing related to the touch panel 230, such as scanning control. For example, the touch panel driver can scan each sensor in an electrostatic capacitance transparent electrode pattern in the X-direction and Y-direction and detect the electrostatic capacitance value of each sensor to determine when a touch operation is performed. The touch panel driver can output a coordinate and corresponding electrostatic capacitance value for each sensor. The touch panel driver can also output a sensor identifier that can be mapped to a coordinate on the touch panel display screen. Additionally, the touch panel driver and touch panel sensors can detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. Signals can be transmitted by the touch panel driver, e.g. in response to a detection of a touch operation, in response to a query from another element based on timed data exchange, etc.

The touch panel 230 and the display 220 can be surrounded by a protective casing, which can also enclose the other elements included in the electronic device 200. According to aspects of the disclosure, a position of the user's fingers on the protective casing (but not directly on the surface of the display 220) can be detected by the touch panel 230 sensors. Accordingly, the controller 210 can perform display control processing described herein based on the detected position of the user's fingers gripping the casing. For example, an element in an interface can be moved to a new location within the interface (e.g., closer to one or more of the fingers) based on the detected finger position.

Further, according to aspects of the disclosure, the controller 210 can be configured to detect which hand is holding the electronic device 200, based on the detected finger position. For example, the touch panel 230 sensors can detect a plurality of fingers on the left side of the electronic device 200 (e.g., on an edge of the display 220 or on the protective casing), and detect a single finger on the right side of the electronic device 200. In this exemplary scenario, the controller 210 can determine that the user is holding the electronic device 200 with his/her right hand because the detected grip pattern corresponds to an expected pattern when the electronic device 200 is held only with the right hand.

The operation key 240 can include one or more buttons or similar external control elements, which can generate an operation signal based on a detected input by the user. In addition to outputs from the touch panel 230, these operation signals can be supplied to the controller 210 for performing related processing and control. According to aspects of the disclosure, the processing and/or functions associated with external buttons and the like can be performed by the controller 210 in response to an input operation on the touch panel 230 display screen rather than the external button, key, etc. In this way, external buttons on the electronic device 200 can be eliminated in lieu of performing inputs via touch operations, thereby improving water-tightness.

The antenna 206 can transmit/receive electromagnetic wave signals to/from other external apparatuses, and the short-distance wireless communication processor 207 can control the wireless communication performed between the other external apparatuses. Bluetooth, IEEE 802.11, and near-field communication (NFC) are non-limiting examples of wireless communication protocols that can be used for inter-device communication via the short-distance wireless communication processor 207.

The electronic device 200 can include a motion sensor 208. The motion sensor 208 can detect features of motion (i.e., one or more movements) of the electronic device 200. For example, the motion sensor 208 can include an accelerometer to detect acceleration, a gyroscope to detect angular velocity, a geomagnetic sensor to detect direction, a geo-location sensor to detect location, etc., or a combination thereof to detect motion of the electronic device 200. According to aspects of the disclosure, the motion sensor 208 can generate a detection signal that includes data representing the detected motion. For example, the motion sensor 208 can determine a number of distinct movements in a motion (e.g., from start of the series of movements to the stop, within a predetermined time interval, etc.), a number of physical shocks on the electronic device 200 (e.g., a jarring, hitting, etc., of the electronic device 200), a speed and/or acceleration of the motion (instantaneous and/or temporal), or other motion features. The detected motion features can be included in the generated detection signal. The detection signal can be transmitted, e.g., to the controller 210, whereby further processing can be performed based on data included in the detection signal. The motion sensor 208 can work in conjunction with a Global Positioning System (GPS) 260. The GPS 260 detects the present position of the electronic device 200. The information of the present position detected by the GPS 260 is transmitted to the controller 210. An antenna 261 is connected to the GPS 260 for receiving and transmitting signals to and from a GPS satellite.

Electronic device 200 can include a camera 209, which includes a lens and shutter for capturing photographs of the surroundings around the electronic device 200. In an embodiment, the camera 209 captures surroundings of an opposite side of the electronic device 200 from the user. The images of the captured photographs can be displayed on the display panel 220. A memory saves the captured photographs. The memory can reside within the camera 209 or it can be part of the memory 250. The camera 209 can be a separate feature attached to the electronic device 200 or it can be a built-in camera feature.

An icon is a pictogram displayed on a computer or mobile device screen, which is designed to assist a user in navigating the computer or mobile device system. Most icons are designed as a quick comprehensible symbol of a software tool, function, or a data file that is accessible on the computer or mobile device system. It is analogous to a traffic sign to give a detailed illustration of an actual entity it represents. Icons can serve as an electronic hyperlink or a file shortcut to access a program or data. A user can activate an icon via a mouse, pointer, finger, or by voice command to allow the user to move directly into and out of the identified function without knowledge of the location or requirements of the file or code.

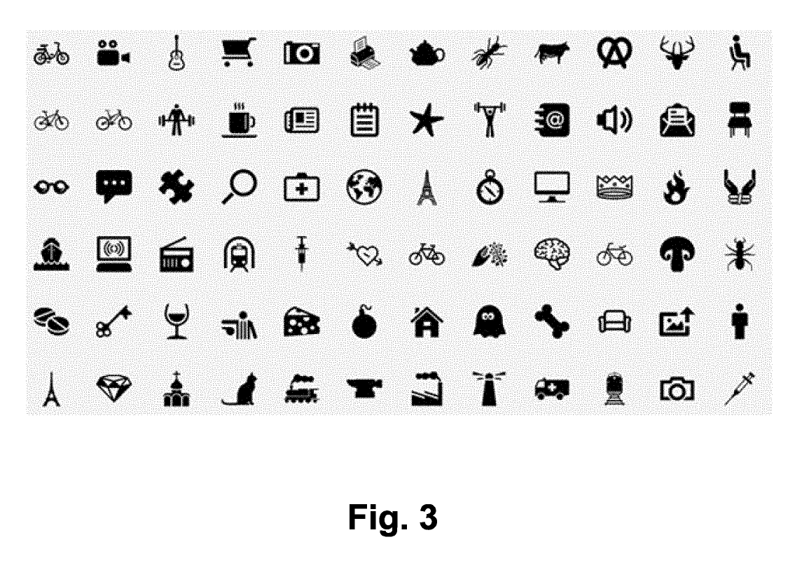

An icon is part of a graphical user interface (GUI) of a computer system. FIG. 3 illustrates a small sample of exemplary icons that could be used as pictograms of a software tool, function, or a data file that is accessible on the computer or mobile device system. A displayed icon is a visual representation of the software tool, function, or data file. One group of icons can be found across most electronic devices, such as a power on/off symbol. A second group of icons can represent desktop objects from an office or other work environment. A third group of icons can be brand icons used to identify commercial software programs. The commercial icons serve as functional links on the system leading to a program or data files created by a specific software provider.

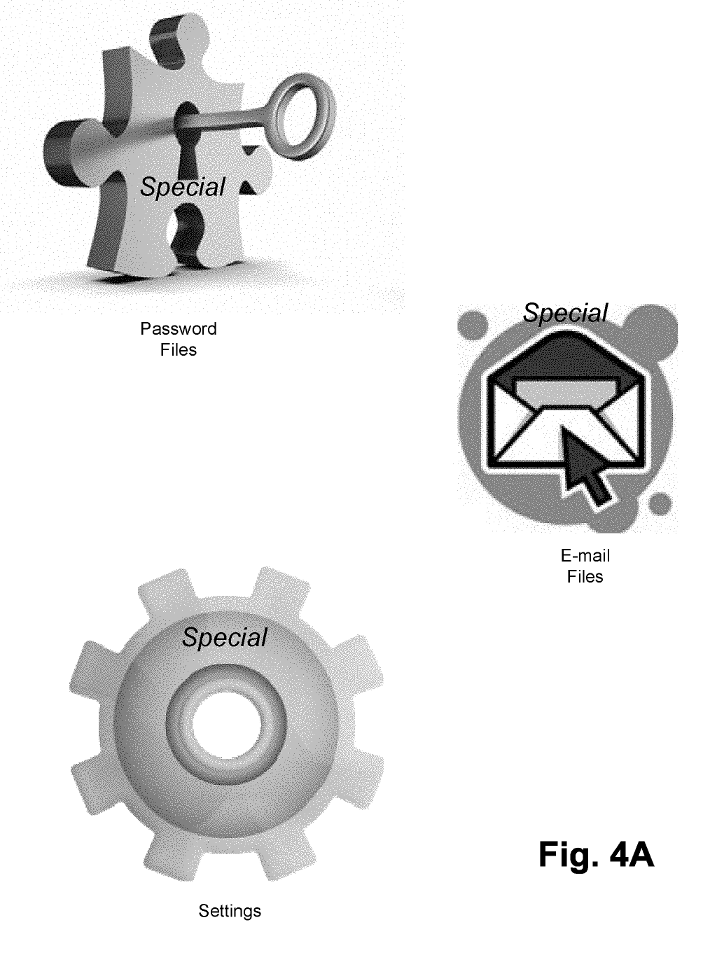

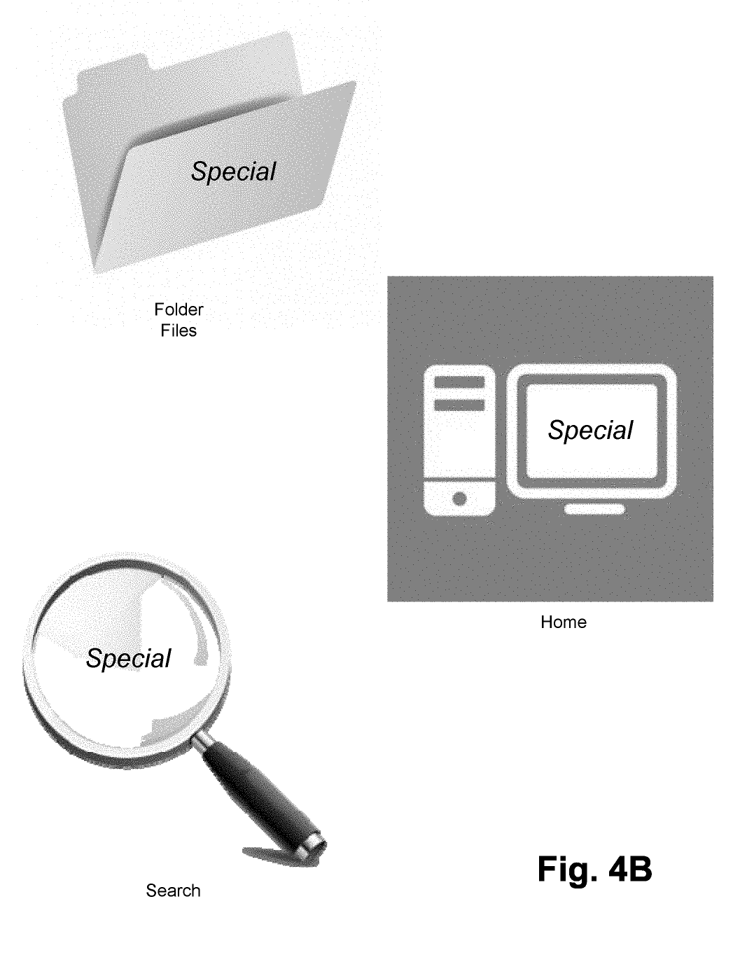

Organization and placement of icons on a display screen can improve the efficiency of a user, especially for a large number of icons and for a mobile device having a smaller display screen. FIGS. 4A and 4B illustrate some special icons that could be used for password files, e-mail files, settings, folder files, home, and search.

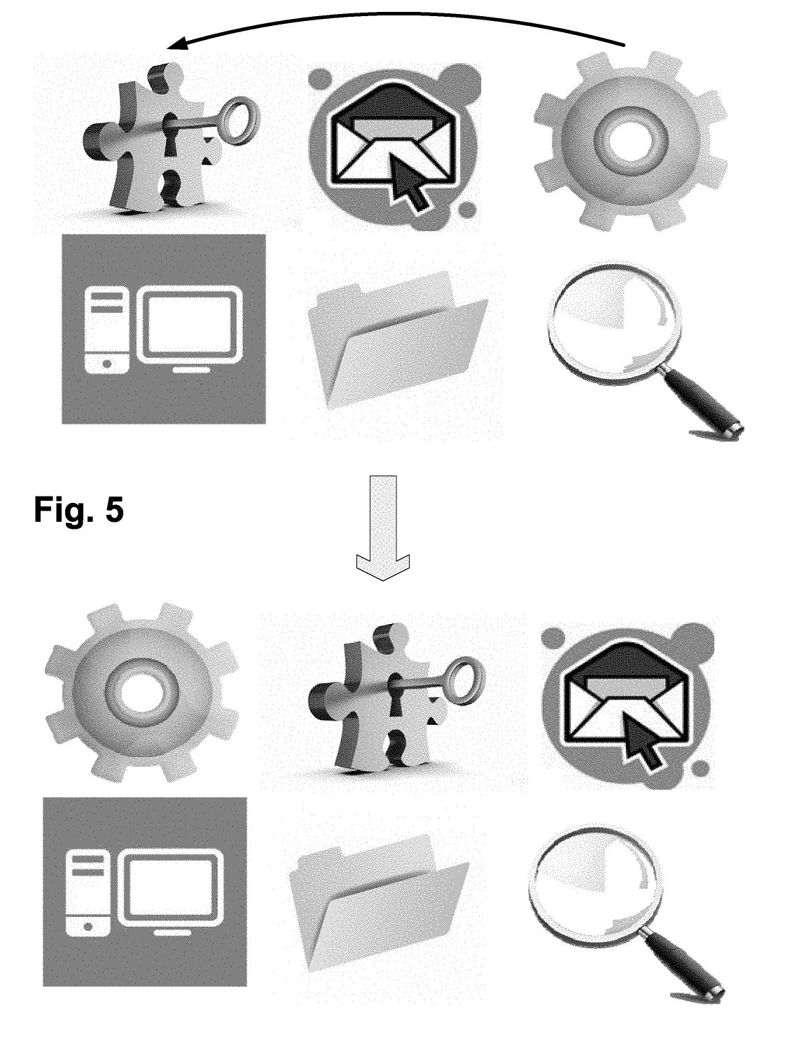

FIG. 5 illustrates an exemplary reorganization of icons according to embodiments described herein. The upper portion of FIG. 5 illustrates an exemplary order in which the icons illustrated in FIGS. 4A and 4B could be arranged on a display screen. When a new file is downloaded or a new notification is received, the associated icon can automatically be moved into a prominent display screen area, such as the upper left corner of the display screen. FIG. 5 illustrates a change or addition of data to the settings of the electronic device. As a result, the settings icon automatically moves to an upper left portion of the display screen, as illustrated in the lower portion of FIG. 5. The password files icon and the e-mail files icon are shifted one position to the right to accommodate moving the settings icon to a prominent upper left position of the display screen.

In an embodiment, various display icon manipulations can be used to provide a variety of data, file, and folder activities. A touch panel of an electronic device is configured to receive one or more inputs from a user on a GUI displayed on a display screen to initiate one or more functions. The electronic device includes circuitry configured to open a displayed icon when a first extended touch of a time equal to or greater than a minimum time of touch by a finger or stylus is detected upon the displayed icon on the touch panel. In an example, an extended touch is longer than a quick tap upon the displayed icon on the touch panel. An extended touch entails holding the finger or stylus upon the displayed icon for a minimum time, such as one to two seconds. An extended touch is comparable to holding down an electronic key such that the electronic key function is repeated multiple times. For example, holding down an electronic backspace key will result in multiple characters being deleted. A displayed icon is a visual representation of a software tool, function, or data file. Therefore, opening a displayed icon is actually opening the underlying software tool, function, or data file.

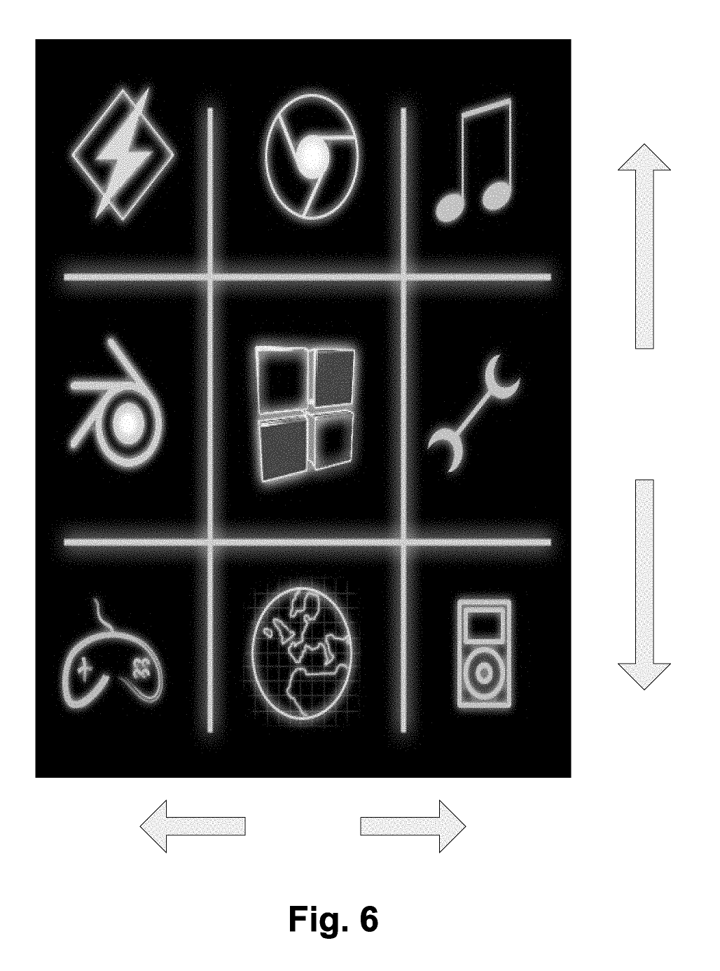

In a touch display screen, the displayed icons can be moved up, down, left, or right by a scrolling motion of a finger or stylus across the display screen, as illustrated in FIG. 6. In an embodiment, each of the four scrolling motions towards an edge of the display screen can be programmed by circuitry to activate one or more designated actions. In an embodiment, given for illustrative purposes only, an upward scrolling motion can activate a date, time, or other everyday task notification. A downward scrolling motion can activate WiFi, Bluetooth, airplane mode, location, settings, battery status, display lighting, and/or identification. A left scrolling motion can activate a search function or other designated task. A right scrolling motion can activate cloud files, storage, or other designated tasks.

Multiple combinations of tools, functions, and/or files for each of the four scrolling directions can be designated by a user. In addition, a minimum scrolling threshold can be established, such that a small scrolling motion does not activate the designated actions. Each designated action would only be activated when a scrolling motion exceeded the minimum scrolling threshold of distance, pressure, and/or time of touch. As an example given for illustrative purposes only, a minimum scrolling threshold could be established for a distance of one-half of the display screen length or width, a pressure exceeding a light touch, and/or a time of one-half second. Other thresholds and combinations could be established according to user preferences.

The electronic device can also include circuitry configured to display one or more sets of properties of the displayed icon when one or more fast clicks by the finger or stylus are detected upon the displayed icon. A time of touch can be defined using the parameters described herein for a quick tap to the displayed icon on the touch panel of the electronic device. The time could be comparable to striking a keyboard key with the intention of selecting the letter or symbol represented by the key just one time, rather than an extended key-holding time resulting in a multiple repeated selection of the letter or symbol.

In an embodiment, the electronic device can include circuitry configured to display a first, second, third, or fourth set of properties of the displayed icon in response to detecting a corresponding one, two, three, or four fast clicks by the finger or stylus upon the displayed icon on the touch panel of the electronic device. Each of the one, two, three, or four fast clicks would be fast clicks comparable to a quick tap. In addition, the multiple fast clicks would occur in rapid succession, such that the multiple fast clicks would be received and interpreted as a single action.

Four fast clicks have been given for illustrative purposes only. More or less than four fast clicks can be implemented to display more or less than four sets of properties of the displayed icon, depending upon a user preference. In an embodiment, the more important properties or the more frequently used properties can be assigned to one fast click, a secondary set of properties can be assigned to two fast clicks, and so on. In another embodiment, the sets of properties can be grouped according to similar types of properties.

Embodiments described herein provide a customized touch screen configured for automatic prominent placement of an icon receiving a downloaded file or a new notification, as well as automatic activation of designated action(s) or properties upon a scrolling motion to one of the four screen edges. In addition, different modes of touching an icon can also be utilized to produce associated actions and/or properties.

The control panel of an icon includes, but is not limited to the icon's color, size, password, voice tag, and/or position in response to movement of a touching finger or stylus. A voice tag would allow a user to call the icon or give designated commands, as recognized by the registered voice of the user. Other control panel properties of an icon are contemplated by embodiments described herein.

The properties of an icon can be controlled, such as minimizing the icon, changing the icon's color, voice tagging the icon, and/or password securing the icon. Securing the icon includes, but is not limited to adding a personal identification number (PIN), registering a password pattern, or registering a one-digit or five-digit finger print. Icon properties can be determined and registered by the user, or default icon properties can be used. Other properties of an icon that can be controlled include, but are not limited to sending, printing, tagging, deleting, editing the file's name, voice tagging, and/or password registration of the selected file.

In an embodiment, the electronic device can include circuitry configured to activate one or more features of a displayed icon when a second extended touch by a finger or stylus is detected upon the displayed icon on the touch panel of the electronic device, subsequently followed by a continuous scrolling motion upon the displayed icon towards an edge of the touch panel. A continuous scrolling motion can be defined as holding the finger or stylus upon the displayed icon while the displayed icon is being moved towards an edge of the touch panel. The finger or stylus controls the path of the displayed icon during its entire movement. A time of the second extended touch is less than a time of the first extended touch, but longer than a fast click.

In an example given for illustrative purposes only, an extended time of touch can be made to an icon of a word processing file. In addition to the extended touch, a subsequent continuous scrolling motion to the top edge of the display screen will print the file, a subsequent continuous scrolling motion to the bottom edge of the display screen will tag the file, a subsequent continuous scrolling motion to the right edge of the display screen will delete the file, and a subsequent continuous scrolling motion to the left edge of the display screen will attach the file to an e-mail for subsequent mailing. Various other actions for an extended touch upon a displayed icon subsequently followed by a continuous scrolling motion to each of the four display screen edges can be designated for each type of icon according to user preferences.

In an embodiment, the electronic device can include circuitry configured to transfer data of a file or folder represented by a displayed icon from a first electronic device to a second electronic device when the second electronic device is located within a distance equal to or less than a maximum threshold distance. The data is transferred when a third extended touch by a finger or stylus is detected upon the displayed icon representing the file or folder, subsequently followed by a rolling scroll motion upon the displayed icon towards the second electronic device. A rolling scroll motion can be defined as making a tossing or flinging motion by the finger or stylus upon the displayed icon. The finger or stylus does not continue to contact the displayed icon after it is tossed towards an edge of the touch panel. A time of the third extended touch is less than a time of the first extended touch, but longer than a fast click.

In another embodiment, the electronic device includes circuitry configured to detect a relative direction of the second electronic device, and transfer the data from the first electronic device with the rolling scroll motion towards the second electronic device subsequent to the third extended touch upon the displayed icon. The transfer of data from the first electronic device to the second electronic device occurs without an intermediary computing device.

In yet another embodiment, data can be transferred to more than one device simultaneously when more than one device is in the scrolling location and within the maximum threshold distance. The data from the first electronic device is simultaneously transferred to a second and third electronic device when the scrolling location from the first electronic device is towards the second and third electronic devices.

Embodiments herein describe a touch, multiple extended touches, a fast click, and a succession of multiple fast clicks implemented by a finger or stylus upon a touch panel of an electronic device. However, the received actions of a touch, multiple extended touches, a fast click, and a succession of multiple fast clicks, as well as a rolling scroll and a continuous scrolling motion can also be implemented by an input device, such as a mouse.

An electronic device having circuitry configured to manipulate and control multiple icon capabilities is described herein, which provides effective and independent transfer computing capabilities without the need for an intermediary computing device. Multiple icons are described herein. However, embodiments for an electronic device are not limited to any of the icons described.

A cloud files icon opens up the storage capacity of the electronic device. A user can back up important files in the cloud. Cloud storage can also support specific vendor cloud storage.

A recycle files icon can contain all files the user has deleted, and also give the user the ability to restore any of the deleted files. It also allows the user to permanently remove any of the files from the electronic device.

An e-mail icon allows e-mail to be sent and received. Files can be downloaded and/or uploaded from the e-mail. Three e-mail icons include an upload icon to upload files for sending by e-mail, a download icon to download files from an e-mail, and an e-mail icon to send and receive e-mails. The electronic device can be formatted by a specific e-mail, wherein the electronic device can be located via the specific e-mail, such as by an alarm or denoting the device's location.

A tag files icon allows a user to identify important files and folders. This is particularly useful when a large number of files and/or folders are present on the electronic device.

A folder icon allows a user to denote any particular file or files within a designated folder. There is no required classification for copying or placement of files within a folder. A user can also create a compressed folder for excessive data within a single folder. A user identification (ID) icon provides an array of information for the user including, but not limited to name, age, address, phone number, and e-mail address(es). Information within the user ID icon can help in contacting the user when the electronic device has been lost.

A settings icon allows a user to control an array of features on the electronic device. Features include, but are not limited to WiFi capabilities, Bluetooth, NFC, airplane mode, display, sound and notification, storage, battery status, and GPS. GPS can be used to assist in locating a lost electronic device. Features also include applications, users, security, account information, language and input, backup and reset, date and time, printing, and information about the electronic device.

A printer icon provides a mechanism to hold files that have been designated for printing. It can also provide a mechanism to hold files that have already been printed.

A basket icon holds one or more files that are waiting for further instructions from a user. An example includes holding a file that needs to be sent within an e-mail by the user.

A task icon includes all tasks designated to be completed by the user. The tasks can be associated with a notification, such as a notification bar or a message on the display screen of an upcoming task that is due to be completed. Another notification can occur via e-mail when a task is coming due.

A record files icon can include voice-record files and video-record files. Separate icons for voice and video can be configured on the electronic device.

A store icon has a plurality of applications available to the electronic device. Since the electronic device system is not open source, all applications need approval to be in the store.

A search icon provides a searching queue for locating files and/or folders. It can be activated by typing a query in a search box or by a voice tag.

A special application icon uses one or more sensors within the electronic device to support or activate an application.

The icons described herein are exemplary only, and other icons can be used in place of or in addition to the icons described herein with the electronic device. The icons are controlled by circuitry of the electronic device used in conjunction with associated software to execute the functions represented by the displayed icons.

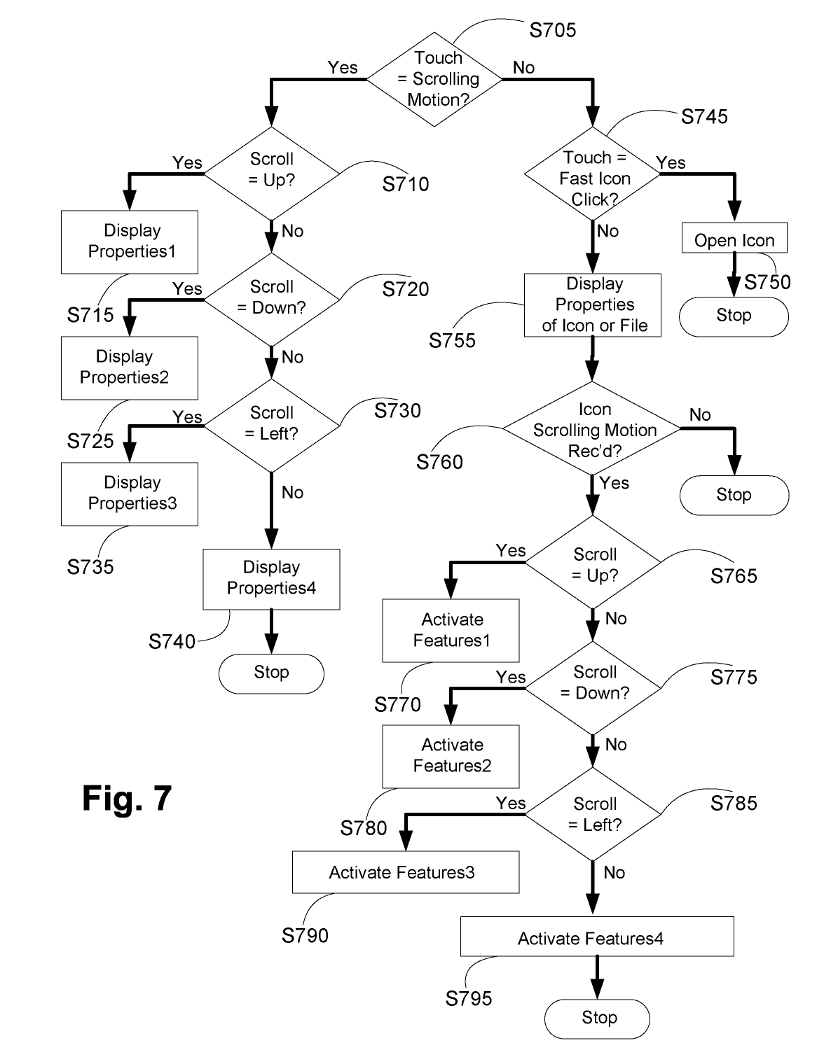

FIG. 7 is an algorithm for an alternative embodiment of manipulating icons on a touchscreen of an electronic device. The exemplary algorithm begins when a touch is received upon the touchscreen. In step S705, it is determined whether the received touch is a scrolling motion. When the received touch is a scrolling motion (a “yes” decision), the exemplary algorithm determines the direction in which the scrolling occurred. In step S710, it is determined whether the scrolling direction is upward. When the scrolling direction is upward (a “yes” decision), a first set of properties of the electronic device is displayed in step S715, wherein the first set of properties was previously established for an upward scrolling direction. In an example, the upward scrolling direction could activate a notification, date, time, or task.

When the scrolling direction is not upward (a “no” decision in step S710), it is determined whether the received scrolling direction is downward in step S720. When the received scrolling direction is downward (a “yes” decision), a second set of properties of the electronic device is displayed in step S725, wherein the second set of properties was previously established for a downward scrolling direction. In an example, the downward scrolling direction could activate WiFi, Bluetooth, airplane mode, the device's location, settings, or a battery status.

When the scrolling direction is not downward (a “no” decision in step S720), it is determined whether the received scrolling direction is leftward in step S730. When the scrolling direction is leftward (a “yes” decision), a third set of properties of the electronic device is displayed in step S735, wherein the third set of properties was previously established for a leftward scrolling direction. When the scrolling direction is not leftward (a “no” decision in step S730), a fourth set of properties of the electronic device is displayed in step S740, wherein the fourth set of properties was previously established for a rightward scrolling direction.

When the received touch is not a scrolling motion (a “no” decision in step S705), it is determined whether the received touch is a fast icon click in step S745. When the received touch is a fast icon click (a “yes” decision), the icon is opened in step S750. When the received touch is not a fast icon click (a “no” decision in step S745), properties of the touched icon or file are displayed in step S755 in response to a received extended touch.

In step S760, it is determined whether an icon scrolling motion is received, in addition to the received extended touch. When an icon scrolling motion is received (a “yes” decision), the exemplary algorithm determines the direction in which the scrolling occurred. In step S765, it is determined whether the scrolling direction is upward. When the scrolling direction is upward (a “yes” decision), a first set of features of the displayed icon is activated in step S770, wherein the first set of features was previously established for an upward scrolling direction.

When the scrolling direction is not upward (a “no” decision in step S765), it is determined whether the received scrolling direction is downward in step S775. When the received scrolling direction is downward (a “yes” decision), a second set of features of the displayed icon is activated in step S780, wherein the second set of features was previously established for a downward scrolling direction.

When the scrolling direction is not downward (a “no” decision in step S775), it is determined whether the received scrolling direction is leftward in step S785. When the scrolling direction is leftward (a “yes” decision), a third set of features of the displayed icon is activated in step S790, wherein the third set of features was previously established for a leftward scrolling direction. When the scrolling direction is not leftward (a “no” decision in step S785), a fourth set of features of the displayed icon is activated in step S795, wherein the fourth set of features was previously established for a rightward scrolling direction.

Embodiments described herein include an electronic device having a controller, a display screen, a touch panel, and one or more of a USB port, a micro USB port, a micro HDMI slot, a memory card slot, and a charging port. The electronic device also includes one or more of a light sensor, an accelerometer, a gyroscopic sensor, a proximity sensor, a compass, a barometer, and a gesture sensor. The electronic device also includes one or more communication processors, wherein the electronic device is configured to directly transfer data to another electronic device without using an intermediary computing device. The communication processors can include one or more of WiFi, Bluetooth, NFC, and IR.

The electronic device can also include a ports light configured to illuminate one or more of the USB port, the micro USB port, the micro HDMI slot, the memory card slot, and the charging port. The electronic device can also include a battery charger. The display screen and the touch panel of the electronic device can include curved edges.

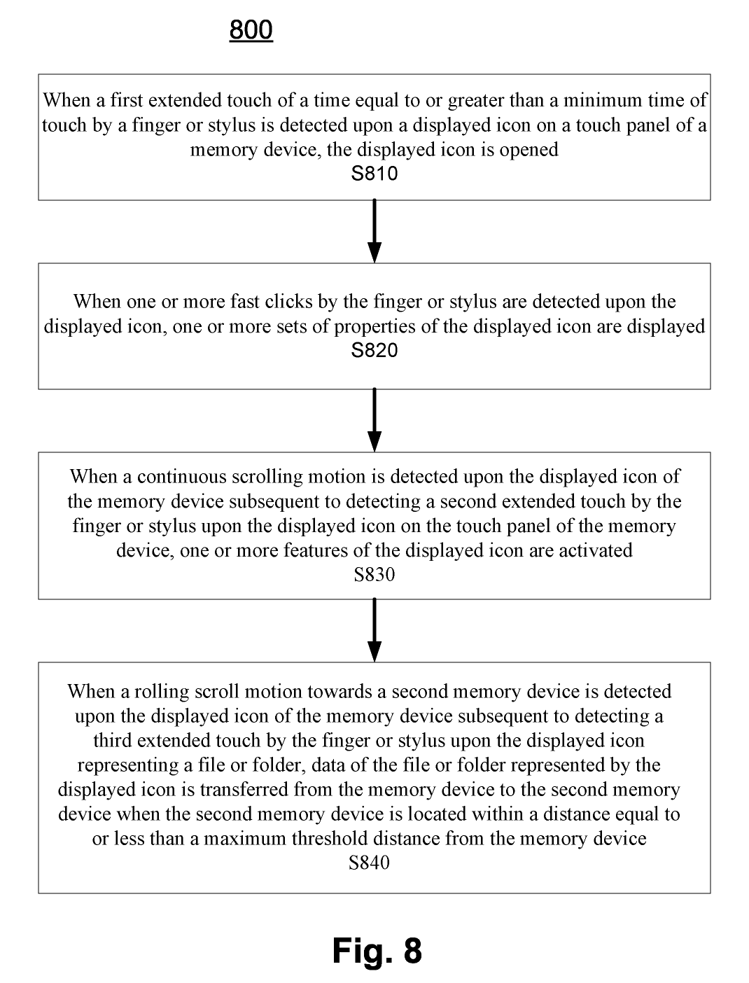

An exemplary method 800 of manipulating data is illustrated in a flowchart of FIG. 8. When a first extended touch of a time equal to or greater than a minimum time of touch by a finger or stylus is detected upon a displayed icon on a touch panel of a memory device, the displayed icon is opened in step S810. When one or more fast clicks by the finger or stylus are detected upon the displayed icon, one or more sets of properties of the displayed icon are displayed in step S820. When a continuous scrolling motion is detected upon the displayed icon of the memory device subsequent to detecting a second extended touch by the finger or stylus upon the displayed icon on the touch panel of the memory device, one or more features of the displayed icon are activated in step S830. A time of the second extended touch is less than a time of the first extended touch. When a rolling scroll motion towards a second memory device is detected upon the displayed icon of the memory device subsequent to detecting a third extended touch by the finger or stylus upon the displayed icon representing a file or folder, data of the file or folder represented by the displayed icon is transferred from the memory device to the second memory device when the second memory device is located within a distance equal to or less than a maximum threshold distance from the memory device in step S840. A time of the third extended touch is less than a time of the first extended touch.

The method 800 of manipulating data can also include automatically moving the displayed icon to a prominent display screen position when a new file or a new notification is received by the displayed icon. The transferring of data can occur by one of a USB port connection, Bluetooth, or WiFi. The first, second, third, or fourth set of properties can include one or more of date, time, task, settings, battery status, or search. The first, second, third, or fourth set of features can include one or more of edit, tag, delete, send, or print.

Embodiments described herein also include a means for manipulating data of an electronic device, including a means for opening a displayed icon, and a means for displaying one or more sets of properties of the displayed icon. The means for manipulating data also includes a means for activating one or more features of the displayed icon, and a means for transferring data from the electronic device to another electronic device without using an intermediary computing device.

The means for manipulating data can also include a means for moving the displayed icon to a prominent display screen position in response to receiving new data or a new notification. The means for manipulating data can also include a means for detecting a relative direction of the second electronic device and transferring the data from the electronic device to the second electronic device.

Embodiments described herein can be implemented in conjunction with one or more of the devices described with reference to FIGS. 1-2. Embodiments are a combination of hardware and software, and circuitry by which the software is implemented.

The foregoing discussion discloses and describes merely exemplary embodiments of the present disclosure. As will be understood by those skilled in the art, the present disclosure may be embodied in other specific forms without departing from the spirit or essential characteristics thereof. Accordingly, the present disclosure is intended to be illustrative and not limiting of the scope, as well as the claims. The disclosure, including any readily discernible variants of the teachings herein, defines in part, the scope of the foregoing claim terminology such that no subject matter is dedicated to the public.

1. An electronic device, comprising:
a touch panel by which a user selects one or more inputs on a graphical user interface (GUI) displayed on a display screen to initiate one or more functions; and
processing circuitry configured to
open a displayed icon when a first extended touch of a time equal to or greater than a minimum time of touch by a finger or stylus is detected upon the displayed icon on the touch panel of the electronic device,
display one or more sets of properties of the displayed icon when one or more fast clicks by the finger or stylus are detected upon the displayed icon,
activate one or more features of the displayed icon when a continuous scrolling motion is detected upon the displayed icon of the electronic device subsequent to detecting a second extended touch by the finger or stylus upon the displayed icon on the touch panel of the electronic device, wherein a time of the second extended touch is less than a time of the first extended touch, and
transfer data of a file or folder represented by the displayed icon from the electronic device to a second electronic device located within a distance equal to or less than a maximum threshold distance when a rolling scroll motion towards the second electronic device is detected upon the displayed icon of the electronic device subsequent to detecting a third extended touch by the finger or stylus upon the displayed icon representing the file or folder, wherein a time of the third extended touch is less than a time of the first extended touch.

2. The electronic device of claim 1, wherein the processing circuitry is further configured to display a first, second, third, or fourth set of properties of the displayed icon in response to detecting a corresponding one, two, three, or four fast clicks by the finger or stylus upon the displayed icon on the touch panel of the electronic device.

3. The electronic device of claim 1, wherein the processing circuitry is further configured to activate a first, second, third, or fourth feature of the displayed icon in response to detecting the continuous scrolling motion from the finger or stylus upon the displayed icon in a corresponding direction of an upward, downward, leftward, or rightward continuous scrolling motion subsequent to detecting the second extended touch upon the displayed icon on the touch panel of the electronic device.

4. The electronic device of claim 1, wherein the processing circuitry is further configured to detect a relative location of the second electronic device, and transfer the data from the electronic device with the rolling scroll motion towards the second electronic device subsequent to the third extended touch upon the displayed icon.

5. The electronic device of claim 4, wherein the processing circuitry is further configured to move the displayed icon to a prominent display screen position when a new file or a new notification is received by the displayed icon.

6. The electronic device of claim 5, further comprising:
one or more of a light sensor, an accelerometer, a gyroscopic sensor, a proximity sensor, a compass, a barometer, and a gesture sensor.

7. The electronic device of claim 1, wherein the touch panel comprises a fingerprint touch sensor configured to receive a fingerprint pressed against an area of the touch panel and to compare the received fingerprint with a fingerprint stored in a memory of the electronic device.

8. The electronic device of claim 1, wherein the touch panel comprises a fingerprint touch sensor configured to receive one or more fingerprints from one or more finger digits and to compare the received fingerprints with fingerprints stored in a memory of the electronic device.

9. The electronic device of claim 8, wherein the fingerprint touch sensor is configured to receive a pre-determined succession of fingerprints from the one or more finger digits and to compare the received pre-determined succession of fingerprints with the fingerprints stored in the memory of the electronic device.

10. The electronic device of claim 1, further comprising:
communication circuitry that is compatible with one or more of wireless fidelity (WiFi), Bluetooth, near-field communication (NFC), and infrared (IR) protocols.

11. The electronic device of claim 1, further comprising:
a battery charger.

12. The electronic device of claim 1, wherein the electronic device includes an external hard disk drive (HDD) device.

13. A method of manipulating data, the method comprising:
opening the displayed icon, when a first extended touch of a time equal to or greater than a minimum time of touch by a finger or stylus is detected upon a displayed icon on a touch panel of an electronic device;
displaying one or more sets of properties of the displayed icon, when one or more fast clicks by the finger or stylus are detected upon the displayed icon;
activating one or more features of the displayed icon, via a processor, when a continuous scrolling motion is detected upon the displayed icon of the electronic device subsequent to detecting a second extended touch by the finger or stylus upon the displayed icon on the touch panel of the electronic device, wherein a time of the second extended touch is less than a time of the first extended touch; and
transferring data of the file or folder represented by the displayed icon from the electronic device to a second electronic device when the second electronic device is located within a distance equal to or less than a maximum threshold distance from the electronic device, via the processor, when a rolling scroll motion towards the second electronic device is detected upon the displayed icon of the electronic device subsequent to detecting a third extended touch by the finger or stylus upon the displayed icon representing a file or folder, wherein a time of the third extended touch is less than a time of the first extended touch.

14. The method of claim 13, further comprising:
automatically moving the displayed icon to a prominent display screen position when a new file or a new notification is received by the displayed icon.

15. The method of claim 13, further comprising:
detecting a relative location of the second electronic device; and
transferring the data from the electronic device with the rolling scroll motion towards the second electronic device subsequent to the second extended touch by the finger or stylus upon the displayed icon representing the file or folder.

16. The method of claim 13, further comprising:
displaying a first, second, third, or fourth set of properties of the displayed icon in response to detecting a corresponding one, two, three, or four fast clicks by the finger or stylus upon the displayed icon on the touch panel of the memory device.

17. The method of claim 13, further comprising:
activating a first, second, third, or fourth feature of the displayed icon in response to detecting the continuous scrolling motion from the finger or stylus upon the displayed icon in a corresponding direction of an upward, downward, leftward, or rightward continuous scrolling motion subsequent to detecting the third extended touch upon the displayed icon on the touch panel of the memory device.

18. An electronic device, comprising:
means for opening a displayed icon when a first extended touch of a time equal to or greater than a minimum time of touch by a finger or stylus is detected upon a displayed icon on a touch panel of the electronic device;
means for displaying one or more sets of properties of the displayed icon when one or more fast clicks by the finger or stylus are detected upon the displayed icon;
means for activating one or more features of the displayed icon when a continuous scrolling motion is detected upon the displayed icon of the electronic device subsequent to detecting a second extended touch by the finger or stylus upon the displayed icon on the touch panel of the electronic device, wherein a time of the second extended touch is less than a time of the first extended touch; and
means for transferring data of a file or folder represented by the displayed icon from the electronic device to a second electronic device when the second electronic device is located within a distance equal to or less than a maximum threshold distance from the electronic device and when a rolling scroll motion towards the second electronic device is detected upon the displayed icon of the electronic device subsequent to detecting a third extended touch by the finger or stylus upon the displayed icon representing the file or folder, wherein a time of the third extended touch is less than a time of the first extended touch.

19. The electronic device of claim 18, further comprising:
means for moving the displayed icon to a prominent display screen position in response to the displayed icon receiving new data or a new notification.

20. The electronic device of claim 18, further comprising:
means for detecting a relative location of the second electronic device and transferring the data from the file or folder represented by the displayed icon from the electronic device to the second electronic device.
